(19) United States
(12) Patent Application Publication
(10) Pub. No.: US 2014/0195975 A1
(43) Pub. Date: Jul. 10, 2014

(54) DISPLAY APPARATUS AND METHOD OF CONTROLLING A DISPLAY APPARATUS

(71) Applicant: SAMSUNG ELECTRONICS CO., LTD., Suwon-si (KR)

(72) Inventor: Jae-ki KYOUN, Seoul (KR)

(73) Assignee: SAMSUNG ELECTRONICS CO., LTD., Suwon-si (KR)

(21) Appl. No.: 14/148,147

(22) Filed: Jan. 6, 2014

Related U.S. Application Data
(60) Provisional application No. 61/748,904, filed on Jan. 4, 2013.

(30) Foreign Application Priority Data
Jun. 25, 2013 (KR) 10-2013-0073230

(51) Int. Cl. G06F 3/0482; G06F 3/0484

(52) U.S. Cl. CPC G06F 3/0482; G06F 3/04842
USPC 715/825

(57) ABSTRACT

A display apparatus and a control method thereof are provided. The method of controlling a display apparatus includes displaying a list including at least one item, in response to a long press command which presses a predetermined area of a remote controller to control the display apparatus for more than a predetermined period of time being input, entering into an editing mode in order to edit the list, and in response to a predetermined user command being input during the editing mode, editing the list according to the predetermined user command.

### CROSS-REFERENCE TO RELATED APPLICATIONS

This application claims priority from Korean Patent Application No. 10-2013-0073230, filed in the Korean Intellectual Property Office on Jun. 25, 2013, and U.S. Provisional Application No. 61/748,904, filed in the U.S. Patents and Trademark Office on Jan. 4, 2013, the disclosures of which are incorporated herein by reference, in their entireties.

### BACKGROUND

1. Technical Field

Aspects of the exemplary embodiments relate to a display apparatus and a method for controlling the display apparatus. More particularly, the exemplary embodiments relate to a display apparatus capable of editing a list which includes a plurality of displayed items and a method of controlling the display apparatus.

2. Description of the Related Art

Recently, various contents and functions are provided to a display apparatus, such as a television. Specifically, the display apparatuses of the related art used to provide merely broadcast contents. However, recent display apparatuses not only provide broadcast contents but also provide image contents stored in the display apparatus and image contents received from outside. In addition, the display apparatuses of the related art used to merely provide the function of displaying image contents. However, a recent display apparatus not only provides the function of displaying image contents but also provides various functions, such as the functions of web browsing and video calls.

In order to provide various contents and functions, a recent display apparatus provides various lists including at least one item. However, such a display apparatus provides only the lists, and does not provide the function of editing such lists using a remote controller. Thus, it is difficult for a user to edit lists as he or she wants. As a result, the user cannot be provided with customized lists.

### SUMMARY

An aspect of the exemplary embodiments relates to a display apparatus capable of providing a list which is customized for a user by permitting the user to edit the list by using a long press command on a remote controller, and a method of controlling the display apparatus.

A method for controlling a display apparatus according to an exemplary embodiment includes displaying a list including at least one item, and in response to a long press command which presses a predetermined area of a remote controller to control the display apparatus for more than a predetermined time being input, entering into an editing mode to edit the list, and in response to a predetermined user command being input during the editing mode, editing the list according to the predetermined user command.

The entering into an editing mode may include displaying an indicator which indicates that the display apparatus enters into an editing mode.

The displaying an indicator may include displaying the indicator on the highlighted item in response to the display apparatus entering into the editing mode while a highlight is displayed on one of the at least one item.

The editing may include moving the item where the indicator is displayed in a direction which corresponds to the selected key in response to one of four direction keys on the remote controller being selected while the indicator is displayed on one of the at least one item.

The editing may include deleting the item where the indicator is displayed in response to a predetermined button on the remote controller being selected while the indicator is displayed on one of the at least one item.

The editing may include moving the item where the indicator is displayed to another list in response to a command to move an item being input where the indicator is displayed while the indicator is displayed on one of the at least one item.

The long press command may be a command to press one area of a touch screen on the remote controller for more than a predetermined period of time in response to the remote controller comprising a touch screen.

The long press command may be a command to press one of a plurality of buttons on the remote controller for more than a predetermined period of time in response to the remote controller comprising a plurality of buttons.

A display apparatus according to an exemplary embodiment includes a display configured to display a list including at least one item, a remote controller configured to receive a user command, and a controller configured to enter into an editing mode to edit the list in response to a long press command which presses a predetermined area of a remote controller for more than a predetermined period of time being input, and in response to a predetermined user command being input through the remote controller during the editing mode, edit the list according to the predetermined user command,.

The controller may be configured to control the display to display an indicator which indicates that the display apparatus enters into an editing mode.

The controller may be configured to control the display in order to display the indicator on the highlighted item in response to the display apparatus entering into the editing mode while a highlight is displayed on one of the at least one item.

The controller may be configured to control the display to move the item where the indicator is displayed in a direction which corresponds to the selected key in response to one of four direction keys on the remote controller being selected while the indicator is displayed on one of the at least one item.

The controller may be configured to control the display to delete the item where the indicator is displayed in response to a predetermined button on the remote controller being selected while the indicator is displayed on one of the at least one item.

The controller may be configured to control the display to move the item where the indicator is displayed to another list in response to a command to move an item where the indicator is displayed being input through the remote controller while the indicator is displayed on one of the at least one item.

The long press command may be a command to press one area of a touch screen on the remote controller for more than a predetermined period of time in response to the remote controller comprising a touch screen.

The long press command may be a command to press one of a plurality of buttons on the remote controller for more than a predetermined period of time in response to the remote controller comprising a plurality of buttons.

An aspect of an exemplary embodiment may provide display apparatus, including: a display configured to display a list including at least one item; a remote controller configured to receive a user command; and a controller configured to enter into an editing mode in order to edit the displayed list in response to a long press command, wherein the controller is configured to control the display by displaying an indicator on a highlighted item in response to the display apparatus entering into the editing mode.

The long press command may be performed by a user pressing a predetermined area of a remote controller for more than a predetermined period of time.

The controller may be configured to edit the list according to the long press user command in response to a predetermined user command being input through the remote controller during the editing mode.

In response to one of four direction keys on the remote controller being selected while an indicator is displayed on one of the at least one item, the controller may be configured to control the display in order to move the item where the indicator is displayed in a direction which corresponds to the selected key.

As described above, according to various exemplary embodiments, a user may use a remote controller to intuitively and conveniently edit a list by.

### BRIEF DESCRIPTION OF THE DRAWINGS

The above and/or other aspects will be more apparent by describing certain exemplary embodiments with reference to the accompanying drawings, in which:

FIG. 1 is a block diagram which briefly illustrates a configuration of a display apparatus according to an exemplary embodiment;

FIG. 2 is a block diagram which illustrates a detailed configuration of a display apparatus according to an exemplary embodiment;

FIGS. 3 to 8 are views provided to explain a method for editing a list using a remote controller, according to various exemplary embodiments; and

FIG. 9 is a flowchart provided to explain a method of controlling a display apparatus, according to an exemplary embodiment.

### DETAILED DESCRIPTION OF THE EXEMPLARY EMBODIMENTS

It should be observed that the method steps and system components have been represented by conventional symbols in the figure, showing only specific details which are relevant for an understanding of the exemplary embodiments. Further, details be readily apparent to persons ordinarily skilled in the art may not have been disclosed. In the exemplary embodiments, relational terms such as first and second, and the like, may be used to distinguish one entity from another entity, without necessarily implying any actual relationship or order between such entities.

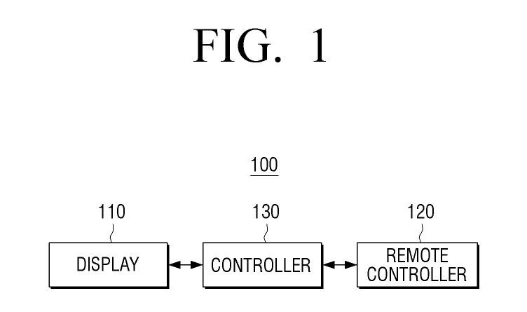

FIG. 1 is a block diagram which briefly illustrates a configuration of a display apparatus according to an exemplary embodiment. As illustrated in FIG. 1, a display apparatus 100 comprises a display 110, a remote controller 120, and a controller 130. In this case, the display apparatus 100 may be implemented as a smart television, but is not limited thereto. The display apparatus 100 may be implemented as various display apparatuses such as a smart phone, a tablet PC, a notebook PC, a desktop PC, and so on.

The display 110 displays image data under the control of the controller 130. In particular, the display 110 may display a list including at least one item. In this case, the list may be an application list including an item which corresponds to an application provided by the display apparatus 100, but is not limited thereto.

The remote controller 120 receives a user command to control the display apparatus 100. In particular, the remote controller 120 may receive a long press command in which a predetermined area of the remote controller 120 is pressed for more than a predetermined period of time (for example, 2 seconds). In this case, in response to the remote controller 120 being a button-type remote controller, the predetermined area for receiving the long press command may be an area where an enter button, from among buttons of the remote controller 120, is located, and in response to the remote controller 120 being a touch screen-type remote controller, the predetermined area for receiving the long press command may be a certain area of the touch screen included in the remote controller 120.

The controller 130 controls overall operations of the display apparatus 100 according to a user command which is input on the remote controller 120 or other input means. In particular, in response to a long press command which presses a predetermined area of the remote controller 120 for more than a predetermined period of time being input, the controller 130 enters into a mode for editing a list displayed on the display 110 (hereinafter, referred to as “editing mode”). In response to the display apparatus 100 entering into the editing mode, the controller 130 may control the display 110 to display an indicator which indicates that the display apparatus 100 enters into the editing mode.

In this case, in response to the display apparatus 100 entering into the editing mode while a highlight is displayed on one of items included in the list, the controller 130 may control the display 110 to display an indicator on the highlighted item. In another exemplary embodiment, the controller 130 may control the display 110 to display an indicator which indicates that the mode of the display apparatus 100 is the editing mode on a predetermined area (for example, an upper left portion) of the display screen.

In addition, in response to a predetermined user command being input through the remote controller 120 during the editing mode, the controller 130 edits the list displayed on the display 110, according to the predetermined user command.

Specifically, in response to a user command to select one of four direction keys on the remote controller 120 being input while the indicator is displayed on one of at least one item, the controller 130 may control the display 110 to move the item where the indicator is displayed in a direction which corresponds to the selected key. In this case, the controller 130 may move the item where the indicator is displayed, not only within the list where the item is included, but also to another list which is different from the list where the item is included.

In addition, in response to a predetermined button (for example, an enter button) on the remote controller 120 being selected while the indicator is displayed on one of at least one item, the controller 130 may control the display 110 to delete the item where the indicator is displayed.

As described above, according to the display apparatus, a user may use a remote controller to more intuitively and conveniently edit a list.

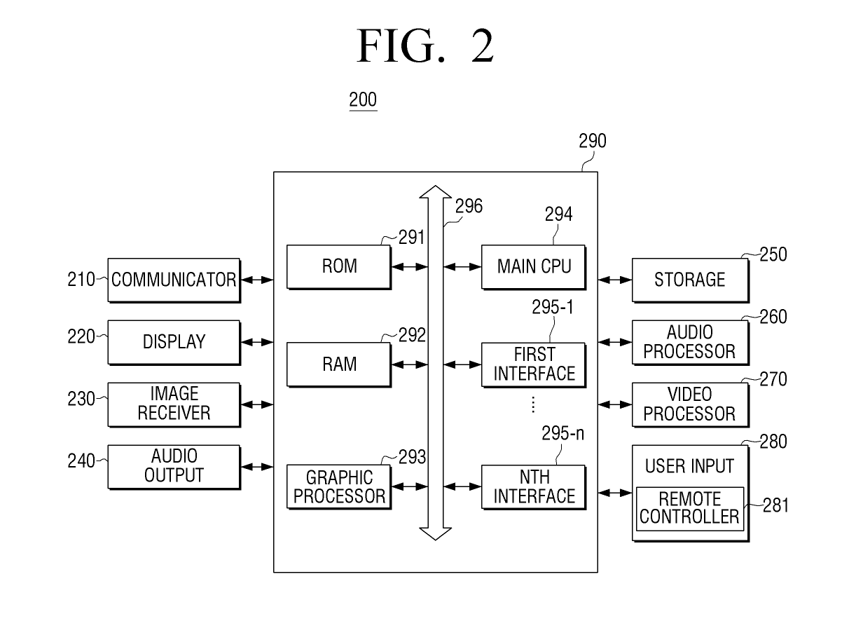

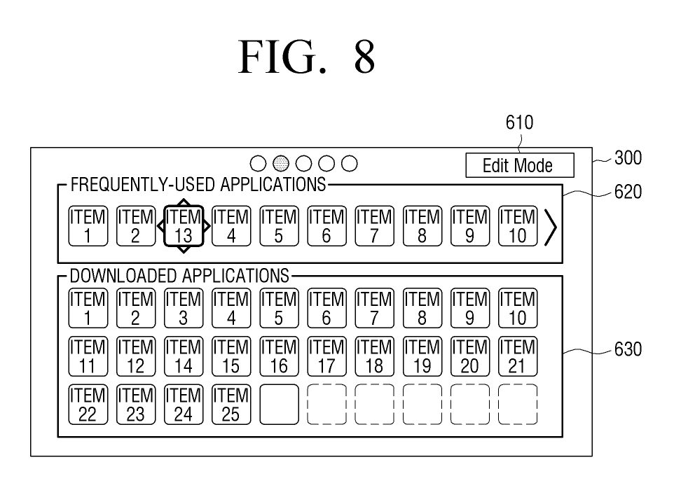

Hereinafter, a display apparatus will be described in greater detail with reference to FIGS. 2 to 8. FIG. 2 is a block diagram which illustrates a detailed configuration of the display apparatus 200 according to an exemplary embodiment. As illustrated in FIG. 2, the display apparatus 200 comprises a communicator 210, a display 220, an image receiver 230, an audio output 240, a storage 250, an audio processor 260, a video processor 270, a user input 280 and a controller 290.

An assumption is made that the display apparatus 200 of FIG. 2 is an apparatus which performs various functions, such as a content recommendation function, a communication function, a video reproduction function, a display function, and so on, and each element is described in a comprehensive manner. Thus, depending on exemplary embodiments, some elements may be omitted or changed, or other elements may be added.

The communicator 210 is a component to perform communication with various types of external apparatuses according to various types of communication methods. In particular, the communicator 210 may comprise various communication modules such as a WiFi chip, a Bluetooth® chip, a Near Field Communication (NFC) chip, a wireless communication chip and so on. In this case, the WiFi chip, the Bluetooth chip®, and the NFC chip perform communication according to a WiFi method, a Bluetooth® method, and an NFC method respectively. The NFC chip refers to a chip which operates according to an NFC method by using 13.56 MHz from among various RF-ID frequency bands such as 135 kHz, 13.56 MHz, 433 MHz, 860-960 MHz, 2.45 GHz, and so on. When the WiFi chip or the Bluetooth® chip is used, various connection information, such as SSID, session key, etc. is received/transmitted in advance so that various information can be received/transmitted using the same. The wireless communication chip refers to a chip which performs communication according to various communication standards such as IEEE®, Zigbee®, 3rd Generation (4G), 3rd Generation Partnership Project (3GPP), Long Term Evolution (LTE), and so on.

The display 220 displays at least one of a video frame which is processed by the video processor 270 after being received from the image receiver 230 and various screens generated by a graphic processor 293. In particular, the display 220 may display a list including a plurality of items. For example, the display 220 may display an application list including items which correspond to applications. In addition, the display 220 may display a plurality of lists on one screen. For example, the display 220 may display a favorite application list including items which correspond to applications which are frequently used by a user and a download application list including items which correspond to downloaded applications on one screen.

The image receiver 230 receives image data through various sources. For example, the image receiver 230 may receive broadcast data from an external broadcast station, and receive image data from an external device (for example, a DVD apparatus).

The audio output 240 is an element which outputs not only various audio data processed by the audio processor 260 but also various sounds and voice messages.

The storage 250 stores various modules to drive the display apparatus 200. For example, the storage 250 may store software including a base module, a sensing module, a communication module, a presentation module, a web browser module and a service module. In this case, the base module refers to a basic module which processes a signal transmitted from each element of hardware included in the display apparatus 200, and transmits the processed signal to an upper layer module. The sensing module is a module which collects information from various sensors, and analyzes and manages the collected information. The sensing module may include a face recognition module, a voice recognition module, a motion recognition module, and an NFC recognition module, and so on. The presentation module is a module to compose a display screen. The presentation module includes a multimedia module for reproducing and outputting multimedia contents, and a UI rendering module for UI and graphic processing. The communication module is a module to perform communication with outside. The web browser module refers to a module which accesses a web server by performing web-browsing. The service module is a module including various applications for providing various services.

As described above, the storage 250 may include various program modules, but some of the various program modules may be omitted, changed, or added according to the type and attribute of the display apparatus 200. For example, in response to the display apparatus 200 is implemented as a tablet PC, the base module may further comprising a location determination module to determine a GPS-based location, and the sensing module may further comprise a sensing module to detect a user motion.

The audio processor 260 is an element which processes audio data. The audio processor 260 may perform various processing with respect to audio data such as decoding, amplification, noise filtering, and so on. The audio data processed by the audio processor 260 may be output to the audio output 240.

The video processor 270 is an element which processes image data received from the image receiver 230. The image processor 270 may perform various processing with respect to image data such as decoding, scaling, noise filtering, frame rate conversion, resolution conversion, and so on.

The user input 280 receives a user command to control overall operations of the display apparatus 200. In this case, the user input 280 includes not only various input apparatuses for controlling the display apparatus 200 such as a touch panel, a pointing device, etc., but also a remote controller 281. In particular, the remote controller 281 may receive a long press command which presses a predetermined area of the remote controller for a predetermined period of time (for example, 2 seconds).

Herein, the remote controller 281 may be implemented as at least one of a remote controller with a touch screen which operates according to a touch screen method and a remote controller with a plurality of buttons which operates according to a button method.

In response to the remote controller 281 being a remote controller based on a touch screen method, the long press command may be a command to press one area of the touch screen on the remote controller 281 for more than a predetermined period of time. When the remote controller 281 is a remote controller based on a button method, the long press command may be a command to press one of a plurality of buttons on the remote controller 281 (for example, an enter button) for more than a predetermined period of time.

The controller 290 controls overall operations of the display apparatus 200 using various programs stored in the storage 250.

As illustrated in FIG. 2, the controller 290 comprises a ROM 291, a RAM 292, a graphic processor 293, a main CPU 294, a first to nth interfaces 295-1˜295-n, and a bus 296. In this case, the RAM 291, the ROM 292, the graphic processor 293, the main CPU 294, and the first to nth interfaces 295-1˜295-n may be connected to each other through the bus 296.

The ROM 292 stores a set of commands for system booting. In response to a turn-on command being input and power being supplied, the main CPU 294 copies an O/S stored in the storage 250 onto the RAM 292 according to a command stored in the ROM 291 and boots a system by executing the O/S. In response to the booting being completed, the main CPU 294 copies various application programs stored in the storage 250 onto the RAM 291 and performs the various operations by executing the application programs copied in the RAM 291.

The graphic processor 293 generates a screen which includes various objects such as an icon, an image, and a text using a computing unit (not shown) and a rendering unit (not shown). The computing unit computes property values such as coordinates, shape, size, and color of each object to be displayed, according to the layout of the screen using a control command received from the user input 280. The rendering unit generates a screen with various layouts including objects based on the property values computed by the computing unit. The screen generated by the rendering unit is displayed within the display area of the display 220. In particular, the graphic processor 293 may generate a UI which includes a feed where a moving image is included.

The main CPU 294 accesses the storage 250 and performs booting using an O/S stored in the storage 250, and performs various operations using various programs, contents, and data stored in the storage 250.

The first to nth interfaces 295-1˜295-n are connected to the above-described various components. One of the interfaces may be a network interface which is connected to an external apparatus via network.

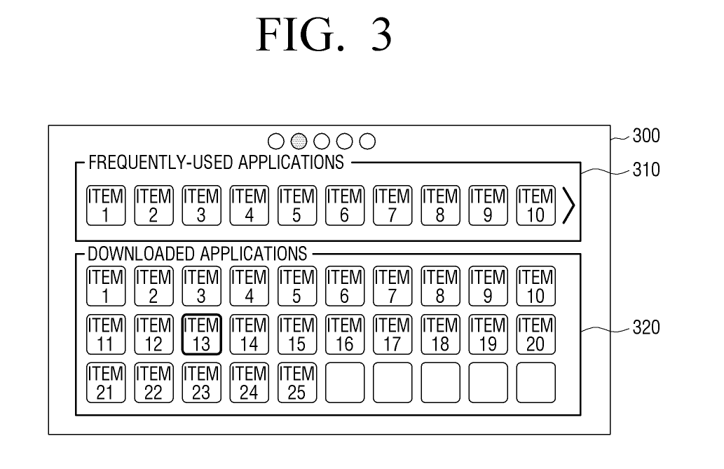

The controller 290 may control the display 220 to display a list which includes a plurality of items. In this case, the controller 290 may control the display 220 to display a plurality of lists on one screen. For example, as illustrated in FIG. 3, the controller 290 may display a first list 310 including items which correspond to the most frequently-used applications and a second list 320 which correspond to items downloaded together on the display apparatus 200.

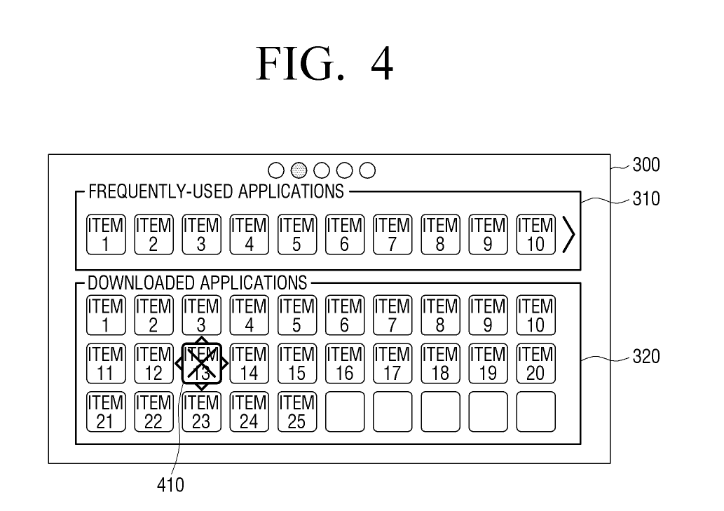

In addition, in response to a long press command being input, which presses a predetermined area for more than a predetermined period of time, the controller 290 enters into an editing mode. In this case, the controller 290 may control the display 220 to display an indicator which indicates that the display apparatus 200 enters into an editing mode in order for a user to edit a list. In particular, in response to the display apparatus 200 entering into the editing mode while a highlight is displayed on one of at least one item, the controller 290 may control the display 220 to display an indicator on the highlighted item. For example, as illustrated in FIG. 3, when the display apparatus 200 enters into the editing mode while a highlight is displayed on a 13th item included in the second list 320, the controller 290 may display an indicator 410 on the 13th item as illustrated in FIG. 4. In this case, the displayed indicator may include arrows indicating that the item may be moved in four directions of the highlight and the text, ‘x’, indicating that the item may be cancelled.

In addition, in response to a predetermined user command being input through the remote controller during the editing mode, the controller 290 may control the display 220 in order to edit a list according to the predetermined user command.

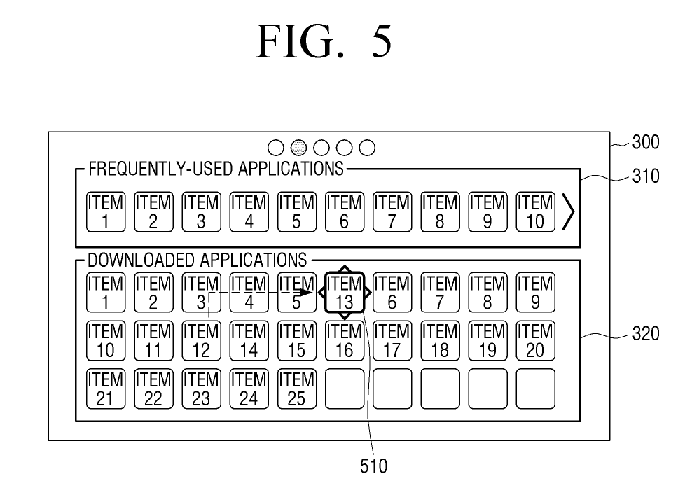

Specifically, in response to a user command to select one of four direction keys on a remote controller being input while an indicator is displayed on one of at least one item included in the list, the controller 290 may control the display 220 to move the item where the indicator is displayed in a direction which corresponds to the selected key. For example, as illustrated in FIG. 4, in response to an up button being selected once and a right button is selected three times while the indicator 410 is displayed on the 13th item of the second list 320, the controller 290 may control the display 220 to move and display the 13th item on the previous location of the 6th item as illustrated in FIG. 5. In this case, when a command to move the item where the indicator is displayed is input, the controller 290 may control the display 220 to remove the text ‘x’ included in the indicator of the item.

In addition, in response to a predetermined button on the remote controller 281 being selected while an indicator is displayed on one of at least one item, the controller 290 may control the display 220 to delete the item where the indicator is displayed. For example, as illustrated in FIG. 4, in response to an enter button of the remote controller being selected while the indicator 410 is displayed on the 13th item of the second list 320, the controller 290 may control the display 220 to delete the 13th item. According to an exemplary embodiment, the controller 290 may perform a deleting operation only when the text, ‘x’ is displayed on the indicator.

According to another exemplary embodiment, in response to the display apparatus 200 entering into an editing mode, the controller 290 may control the display 220 to display an indicator which indicates that the mode of the display apparatus 200 is an editing mode on one area of a display screen. For example, in response to the display apparatus 200 entering into the editing mode, the controller 290 may control the display 220 to display an icon 510 which indicates the editing mode on an upper right area of the display screen.

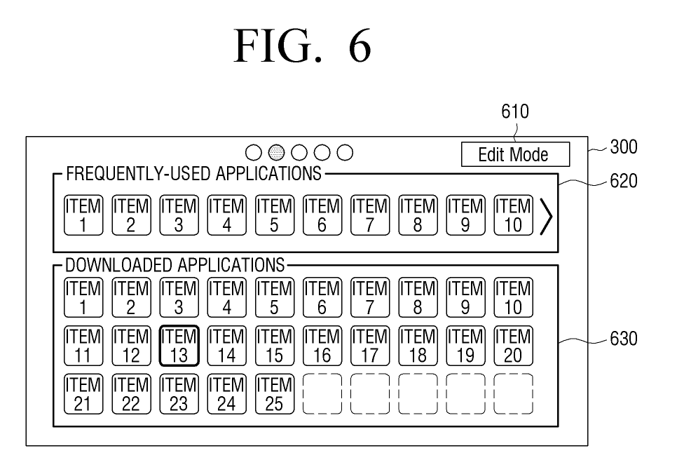

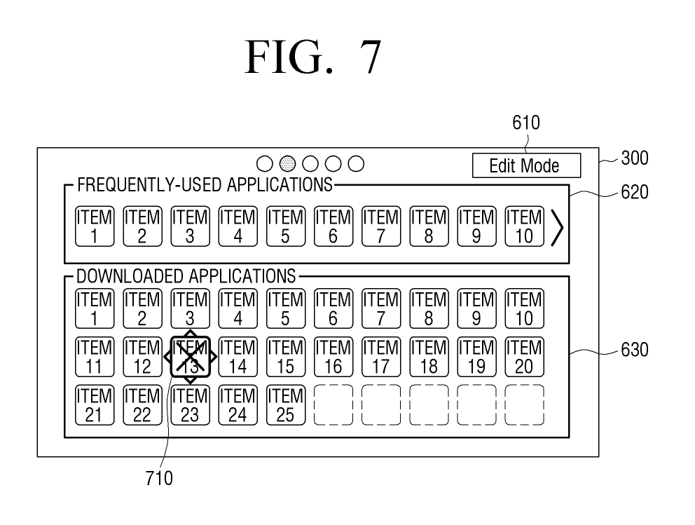

In particular, as illustrated in FIG. 6, in response to a predetermined button (for example, an enter button) of the remote controller 281 being input while an indicator which indicates the editing mode is displayed on an upper right area of the display screen, the controller 290 may control the display 220 to display an indicator 710 on the 13th item where a highlight is displayed, as illustrated in FIG. 7. After the indicator is displayed on an item, the controller 290 may perform an editing operation regarding the item where the indicator is displayed, as illustrated in FIGS. 3 to 5.

In addition, according to an exemplary embodiment, in response to a command to move an item where an indicator is displayed being input through the remote controller 281 while the indicator is displayed on one of at least one item, the controller 290 may control the display 220 to move the item to another list where the indicator is displayed. For example, as illustrated in FIG. 7, when an up button on the remote controller 281 is selected twice while the indicator 710 is displayed on the 13th item of the second list 630, the controller 290 may control the display 220 to display the 13th item of the second list 630 on the location of the 3rd item of the first list 620. That is, in the editing mode of the display apparatus 200, it is possible to move items in a plurality of lists displayed on the display 220.

As described above, according to the display apparatus 200, a user may edit a list displayed on the display apparatus more intuitively by using a remote controller.

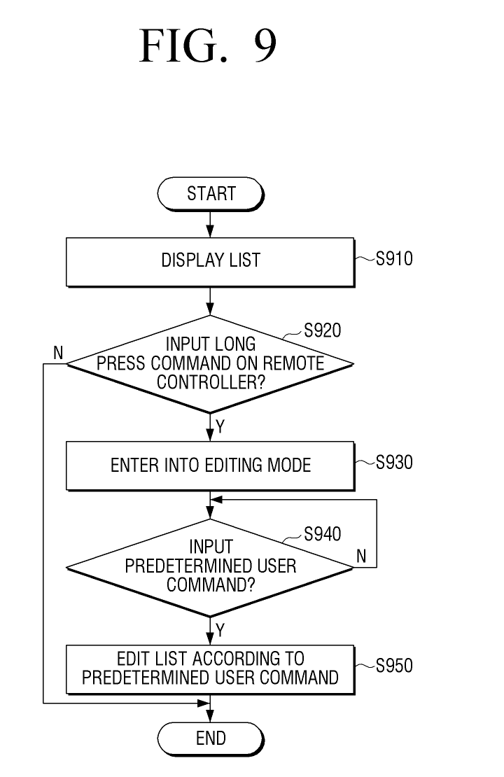

Hereinafter, a method of controlling the display apparatus 100 will be described with reference to FIG. 9.

The display apparatus 100 displays a list including at least one item (S910). In this case, the display apparatus 100 may display a plurality of lists on one screen.

Subsequently, the display apparatus 100 determines whether a long press command is input on the remote controller 120 (S920). In this case, in response to the remote controller 120 being a remote controller based on a touch screen method, the long press command may be a command to press one area of the touch screen on the remote controller 120 for more than a predetermined period of time. In response to the remote controller 120 being a remote controller based on a button method, the long press command may be a command to press one of a plurality of buttons on the remote controller 120 (for example, an enter button) for more than a predetermined period of time.

In response to the long press command being input (S920-Y), the display apparatus 100 enters into an editing mode to edit a list (S930). In this case, the display apparatus 100 may display an indicator which indicates that the display apparatus enters into the editing mode. For example, the display apparatus 100 may display an indicator on an item where a highlight is displayed, and may display the indicator on one area of the display screen.

Subsequently, the display apparatus 100 determines whether a predetermined user command is input (S940). In this case, the predetermined user command may be an editing command to edit a list, and may be a command to perform one of moving and deleting an item.

In response to the predetermined user command being input (S940-Y), the display apparatus 100 edits a list according to the predetermined user command (S950). Specifically, the display apparatus 100 may move or delete an item included in a list according to a user command to move or delete the item included in the list, as described above with respect to FIGS. 3 to 8.

As described above, according to the method of controlling the display apparatus 100, a user may edit a list displayed on a display screen more intuitively and easily by using a remote controller.

Meanwhile, the method of controlling a display apparatus according to various exemplary embodiments may be implemented as a program and provided in the display apparatus. In addition, a non-transitory computer readable storage medium, where the program is stored, may be provided. A non-transitory computer readable storage medium where the program is stored may be provided. The non-transitory recordable storage medium refers to a medium which may store data semi-permanently rather than storing data for a short time such as a register, a cache, and a memory and may be readable by an apparatus. Specifically, the above-mentioned various applications or programs may be stored in a non-temporal recordable medium such as CD, DVD, hard disk, Blu-ray Disc™, USB, memory card, and ROM and provided therein

The foregoing exemplary embodiments and advantages are merely exemplary and are not to be construed as limiting. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of controlling a display apparatus, the method comprising:
displaying a list including at least one item;
entering into an editing mode to edit the list in response to a long press command which presses a predetermined area of a remote controller to control the display apparatus for more than a predetermined period of time being input; and
editing the list according to the predetermined user command in response to a predetermined user command being input during the editing mode.

2. The method as claimed in claim 1, wherein the entering into an editing mode comprises displaying an indicator which indicates that the display apparatus enters into an editing mode.

3. The method as claimed in claim 2, wherein the displaying an indicator comprises displaying the indicator on the highlighted item in response to the display apparatus entering into the editing mode while a highlight is displayed on one of the at least one item.

4. The method as claimed in claim 3, wherein the editing comprises moving the item where the indicator is displayed in a direction which corresponds to the selected key in response to one of four direction keys on the remote controller being selected while the indicator is displayed on one of the at least one item.

5. The method as claimed in claim 3, wherein the editing comprises deleting the item where the indicator is displayed in response to a predetermined button on the remote controller being selected while the indicator is displayed on one of the at least one item.

6. The method as claimed in claim 3, wherein the editing comprises moving the item where the indicator is displayed to another list in response to a command to move an item is input where the indicator being displayed while the indicator is displayed on one of the at least one item.

7. The method as claimed in claim 1, wherein the long press command is a command to press one area of a touch screen on the remote controller for more than a predetermined period of time in response to the remote controller comprising a touch screen.

8. The method as claimed in claim 1, when the remote controller comprises a plurality of buttons, the long press command is a command to press one of a plurality of buttons on the remote controller for more than a predetermined period of time.

9. A display apparatus, comprising:
a display configured to display a list including at least one item;
a remote controller configured to receive a user command; and
a controller configured to enter into an editing mode to edit the list in response to a long press command which presses a predetermined area of a remote controller for more than a predetermined being input, and edit the list according to the predetermined user command in response to a predetermined user command being input through the remote controller during the editing mode.

10. The apparatus as claimed in claim 9, wherein the controller is configured to control the display in order to display an indicator which indicates that the display apparatus enters into an editing mode.

11. The apparatus as claimed in claim 10, wherein the controller is configured to control the display to display the indicator on the highlighted item in response to the display apparatus entering into the editing mode while a highlight is displayed on one of the at least one item.

12. The apparatus as claimed in claim 11, wherein in response to one of four direction keys on the remote controller being selected while the indicator is displayed on one of the at least one item, the controller is configured to control the display in order to move the item where the indicator is displayed in a direction which corresponds to the selected key.

13. The apparatus as claimed in claim 11, wherein the controller is configured to control the display in order to delete the item where the indicator is displayed in response to a predetermined button on the remote controller being selected while the indicator is displayed on one of the at least one item.

14. The apparatus as claimed in claim 11, wherein the controller is configured to control the display in order to move the item from the location where the indicator is displayed to another list in response to a command to move an item where the indicator is displayed is input through the remote controller while the indicator is displayed on one of the at least one item.

15. The apparatus as claimed in claim 9, wherein the long press command is a command to press one area of a touch screen on the remote controller for more than a predetermined period of time in response to the remote controller comprises a touch screen.

16. The apparatus as claimed in claim 9, wherein the long press command is a command to press one of a plurality of buttons on the remote controller for more than a predetermined period of time in response to the remote controller comprising a plurality of buttons.

17. A display apparatus, comprising:
a display configured to display a list including at least one item;
a remote controller configured to receive a user command; and
a controller configured to enter into an editing mode in order to edit the displayed list in response to a long press command, wherein the controller is configured to control the display by displaying an indicator on a highlighted item in response to the display apparatus entering into the editing mode.

18. The display apparatus of claim 17, wherein the long press command is performed by a user pressing a predetermined area of a remote controller for more than a predetermined period of time.

19. The display apparatus of claim 17, wherein the controller is configured to edit the list according to the long press user command in response to a predetermined user command being input through the remote controller during the editing mode.

20. The display apparatus of claim 19, wherein in response to one of four direction keys on the remote controller being selected while an indicator is displayed on one of the at least one item, the controller is configured to control the display in order to move the item where the indicator is displayed in a direction which corresponds to the selected key.
